(19) United States
(12) Patent Application Publication
(10) Pub. No.: US 2009/0303927 A1
(43) Pub. Date: Dec. 10, 2009

(54) Method and System for Controlling Discontinuous Reception/Transmission

(75) Inventors: Troels Emil Kolding, Klaurup (DK); Frank Frederiksen, Klarup (DK)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/367,204

(22) Filed: Feb. 6, 2009

(30) Foreign Application Priority Data
Feb. 6, 2008 (FI) 20085104

(51) Int. Cl. H04W 40/00

(52) U.S. Cl. 370/328

(57) ABSTRACT

A method, a network element, an apparatus and a system for controlling discontinuous reception/transmission during a discontinuous reception/transmission on-period in communication between a transmitter and a receiver, are provided. The control is based on certain well-defined measurements including at least one of the following: the number of bits that are currently in the buffer of the transmitter, the currently supported transport block set for the receiver and the average supported transport block set for the receiver. The measurements are performed at the transmitter in each predefined time interval.

### RELATED APPLICATION

This application claims priority to Finnish Application No. 20085104 filed Feb. 6, 2008, entitled, “Method and System for Controlling Discontinuous Reception/Transmission,” which is hereby incorporated by reference in its entirety.

### TECHNICAL FIELD

This invention relates to a method, a network element, an apparatus and a computer program for controlling a discontinuous reception (DRX) or transmission (DTX) in a communication network.

### BACKGROUND

DRX/DTX is a method used in communication systems to conserve the battery energy of a terminal device. While applying DRX/DTX mechanisms, the terminal device does not keep the receiver/transmitter (transceiver) on constantly, but turns it off when no data is allocated to the terminal device. While the transceiver of the terminal device is in off-period, the terminal device enters the sleep mode and saves battery energy. The DRX/DTX method is implemented between the terminal device and the network by negotiating the times when data transfers takes place.

DRX/DTX may be applied in the Evolved Universal Radio Access Network (E-UTRAN). E-UTRAN is also known as Long Term Evolution (LTE) or 3.9G. LTE is a packet-only system, where data is transferred in packets and the radio resources needed for packet data transfer are assigned to each terminal device by the use of allocation tables (AT) or more generally, by a physical downlink control channel (PDDCH). The assignments are performed as one-time assignments or in a persistent/semi-static manner. Consequently, large variations in the scheduled traffic load per terminal device may exist. Generally, the terminal device is assigned radio resources while it is experiencing the most excellent radio conditions.

The current DRX/DTX concept is characterized by:

the exact time/phase of the starting point of the first on-period

a DRX cycle/period denoting the time interval between two consecutive on-periods

the duration of each on-period

In FIG. 1, the above-mentioned three parameters characterizing the DRX/DTX concept are illustrated. DRX/DTX period 102 consists of on- 104 and off-periods 106. During off-period 106, the transceiver of the terminal device enters the sleep mode and consumes low power. As the off-period 106 of a DRX/DTX period 102 approaches its time-out and the next on-period 104 begins, the transceiver of the terminal device wakes up and receives a new AT, from which the transceiver derives new requirements for data transfers regarding the corresponding terminal device. Additionally, new DRX/DTX settings may be transmitted to the terminal device.

In a DRX/DTX concept, the exact time/phase of the first DRX/DTX on-period starting point 100, the DRX/DTX period/cycle duration 102 and the duration of the DRX/DTX on-period 104 must be clearly agreed upon between the terminal device and the base station. Generally the agreement is reached by a higher layer robust (e.g., hand-shake algorithm) signaling channel, such as a radio resource control (RRC) signaling channel.

However, in current DRX/DTX methods, DRX/DTX settings are static during the DRX/DTX period 102. RRC signaling can be applied to change the DRX/DTX settings only between the DRX/DTX periods 102. This leads to a situation where the DRX/DTX settings during the period may have to be configured beforehand for the worst-case scenarios (e.g., large web sites and short reading periods). Consequently, the terminal device cannot conserve its battery energy in the most efficient way.

### SUMMARY

An object of the invention is to provide an enhanced solution for controlling discontinuous reception or transmission.

According to an aspect of the present invention, there is provided a method as specified in claim 1.

According to another aspect of the present invention, there is provided an apparatus as specified in claim 11.

According to yet another aspect of the present invention, there is provided a computer program product as specified in claim 21.

Further advantages and embodiment of the invention are described in the dependent claims.

### BRIEF DESCRIPTION OF THE DRAWINGS

In the following, the invention will be described in greater detail with reference to the embodiments and the accompanying drawings, in which

FIG. 1 shows an illustration of the discontinuous reception concept as explained earlier;

FIG. 2 illustrates an embodiment of the invention; and

FIG. 3 illustrates an exemplary control procedure for implementing a discontinuous reception concept with discontinuous reception control ability.

### DETAILED DESCRIPTION OF THE DRAWINGS

The following embodiments are exemplary. Although the specification may refer to “an”, “one”, or “some” embodiment(s) in several locations, this does not necessarily mean that each such reference is made to the same embodiment(s), or that a particular feature only applies to a single embodiment. Single features of different embodiments may also be combined to provide other embodiments.

Although, this invention is described using LTE as the basis, it could be applicable to any other wireless mobile communication systems as well. The telecommunication system may have a fixed infrastructure providing wireless services to subscriber terminals, or it may be a purely wireless mobile network. Furthermore, even though the invention is described using a base station as one of the processing units, the base station could be replaced by some other network element such as a radio network controller (RNC).

In the following, the controlling of the DRX/DTX is described based on the DRX concept. A person skilled in the art, will readily acknowledge that the proposed solution can be transferred to DTX as well.

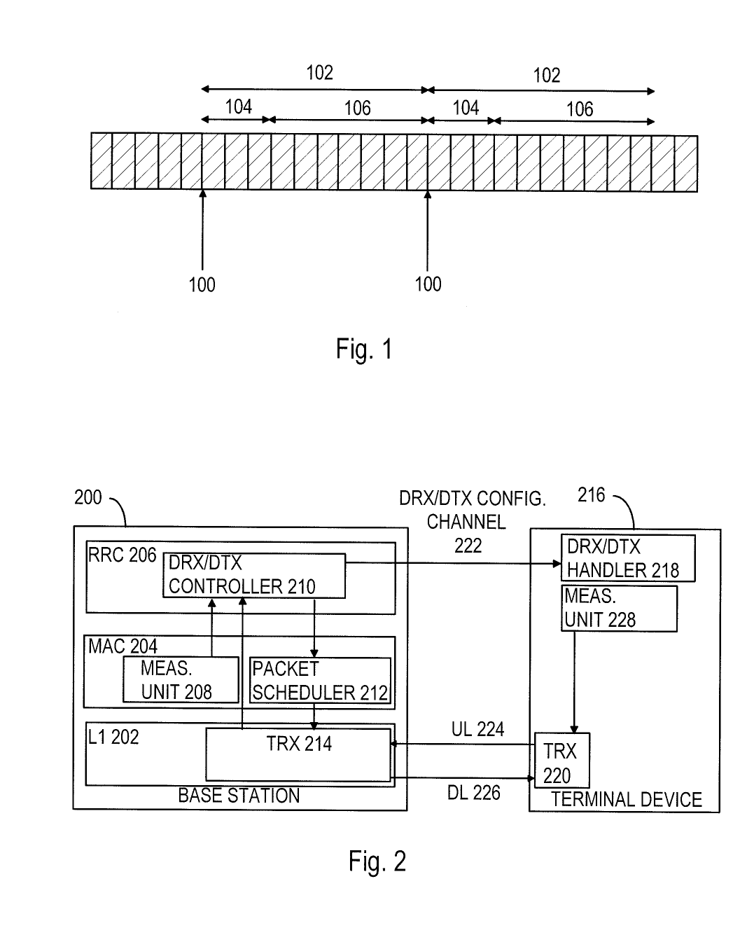

As the power consumption of a terminal device depends on how often it needs to turn the receiver on, it is clear that in order to achieve the best possible power saving, the DRX period 102 referring to FIG. 1, should be as long as possible taking the connection restrictions into account. However, the duration of the DRX period 102 affects also the responsiveness and, hence, the data throughput of the terminal device, and for this reason, a compromise must be made. In ideal cases, the traffic schedule of a terminal device can be predicted reasonably well (e.g., VoIP services) and the DRX settings can be set beforehand to optimize the data throughput/power saving efficiency. This way a terminal device can exploit the periods when data is not transferred, i.e., off-periods 106 and enter the sleep mode to save battery energy. In some other services, such as web browsing, the web sites can vary significantly in size and complexity. Consequently, the download times and inter-download times are random, which may result in the prediction of the optimal DRX settings beforehand being practically impossible. This leads to a situation where the DRX settings for the whole DRX period may have to be configured beforehand for the worst-case scenario. Consequently, the terminal device cannot conserve its battery energy in the most efficient way.

According to an embodiment, the control of the DRX settings may be based on certain well-defined measurements and parameters that may be extracted inside the base station or other network element, or in DTX case, inside the terminal device. In DTX, information regarding the measurement results may be transmitted to the base station. In DRX, the base station may adjust the DRX settings based on the well-defined measurements and transmit information about the adjusted DRX settings to a terminal device via available signaling channels. The adjustment of the DRX settings may occur after each predetermined time interval or the DRX settings may remain static during adjacent predetermined time intervals. The predetermined time interval may be understood as an extent of physical resources (time/frequency/space) to which a single decodable entity is defined. One example of a predetermined time interval may be a transmission time interval (TTI), which may be applied in a communication system with the LTE time division duplex (TDD) concept. In LTE TDD, the length of a TTI may be, e.g., one millisecond. Generally, the length of a DRX cycle/period is several TTIs. For the sake of simplicity, the term TTI is applied in the following description of an embodiment.

A very general architecture of a mobile communication system applying the DRX concept with adaptation ability is shown in FIG. 2. In FIG. 2, a simplified system architecture, with only the required elements and functional entities for understanding the DRX concept with adaptation ability, is presented. Other components have been omitted for the sake of simplicity. The implementation of the elements and functional entities may vary from that shown in FIG. 2. The connections shown in FIG. 2 are logical connections, and the actual physical connections may be different. It is apparent to a person skilled in the art that mobile telecommunication systems also comprise other functions and structures.

In the following, the functionality of the DRX concept with controlling ability is described with reference to FIG. 2. In FIG. 2, a terminal device 216, such as a mobile phone, may be logically connected to the base station 200 via a DRX/DTX configuration channel 222 and radio communication data channels for uplink (UL) 224 and downlink (DL) 226. Both the base station 200 and the terminal device 216 may comprise respective transceiver (TRX) circuits 214 and 220, and are thus capable of transmitting and receiving data.

The base station 200 comprises a physical radio interface layer 202. The physical radio interface layer is also known as layer 1 (L1). L1, comprising transceiver 214, may be used to access the radio channel by sending data to the terminal device 216 via DL radio communication data channel 226 or by receiving data via UL radio communication data channel 224. The L1 202 may further be used to perform channel coding, hybrid automatic repeat request (HARQ) processing, data modulation and mapping. To a certain degree, the L1 202 may be configured to process information signals received and signals to be transmitted. The L1 202 may be configured to filter and amplify the received information signals and to convert the analog information signals into a digital form. The L1 202 may be configured to convert signals to be transmitted to analog waveforms and transmit the analog waveforms through the radio channel.

The base station 200 may further comprise a medium access control (MAC) layer 204. When the DRX concept is applied, the MAC layer 204 may comprise a measurement unit 208. Furthermore, it may comprise a packet scheduler 212. The MAC layer may perform the multiplexing of several logical channels on the same transport channel, error correction through HARQ, priority handling and transport format selection.

The base station 200 may further comprise a radio resource control (RRC) layer 206. The RRC layer 206 may be terminated in base station 200 at the network side and may perform the following operations: broadcasting of system information, paging, RRC connection management, mobility functions, quality of service (QoS) management functions and terminal device measurement reporting and control. The RRC layer 206 may further comprise a DRX/DTX controller 210, which may be used to determine and inform the adjustment of the DRX/DTX settings.

In the end a compromise between the maximum DRX update rate and the power consumption reduction at the terminal device needs to be established. This trade-off can be easily controlled in the base station 200 or in some other network element.

The control feature of the present embodiment may be implemented in the base station 200 as shown in FIG. 2. Certain user-specific input measurements may be performed in the measurement unit 208 in the MAC layer 204 of the base station 200 when DRX concept is applied. These measurements may include the answers to the following questions:

how many bits are currently buffered at the transmitter 200;

what is the currently supported transport block set (TBS) for the receiver 216; and

what was the average supported TBS for the receiver 216 in the past.

The current buffer level and the currently supported TBS may be determined from the current transmission time interval. In DRX, the receiver may be the terminal device and the transmitter may be the base station or some other network element. However, in DTX, the receiver may be the base station or some other network element and the transmitter may be the terminal device. Hence, in DTX, a measurement unit 228 may be located at the terminal device instead of the base station. Although the measurement units 208 and 228 may perform identical measurements, they are separate units. The measurement unit 228 may be capable of transmitting the information regarding the measurements to the TRX 220, which may transmit the information to the TRX 214 of the base station 200 and further to the DRX/DTX controller 210 at the RRC layer 206 at the base station 200. When DRX concept is applied, the measurement unit 208 located at the MAC layer 204 of the base station 200 may be capable of transmitting the information regarding the measurements to the DRX/DTX controller 210 at the RRC layer 206 of the base station 200. Commonly it can be said that the measurement unit 208/228 and the measurements may take place in the transmitter but may be applied in any case at the base station.

The above measurements may be fed as input in the DRX/DTX controller 210 at the RRC layer 206. The DRX/DTX controller 210 may conduct the DRX/DTX configurations and send the DRX/DTX update information to the terminal device 216 via the DRX/DTX configuration channel 222. Although the DRX/DTX configuration channel 222 is illustrated as a higher layer channel (e.g., L3), it may in practice be carried over the L1 channel. In principle, the DRX/DTX configuration channel 222 can be any defined channel between the terminal device 216 and the base station 200.

Adjusted DRX settings which may be sent over the DRX/DTX configuration channel 222 may comprise an option to control, referring to FIG. 1, at least the DRX period duration 102 and preferably also the on-period duration 104. Furthermore, the timing/phase of the start of the DRX period 100 may be included.

With reference to FIG. 2, the DRX/DTX controller 210 may then inform the packet scheduler 212 located at the MAC layer 204 about the new DRX settings (in DRX case), which may be determined based on the above measurements. The packet scheduler 212 may assign resources based on the channel quality, the available resources and the DRX setting information available at the packet scheduler. Consequently, as the packet scheduler 212 may receive information when the terminal device 216 is available for UL/DL transmission, the packet scheduler 212 may apply this information when assigning the radio resources. The DRX setting information may be applied for instance in the resource assignment regarding the UL/DL data transmission channels marked as 224 and 226, respectively. The transmission performed via UL/DL 224, 226 may include, e.g., the allocation table or data itself. As the DRX settings may be sent to the terminal device 216 and more specifically, to a DRX/DTX handler 218, the terminal device 216 may update its DRX settings based on the information received by the DRX/DTX handler 218. Thus, both the base station 200 and the terminal device 216 may be aware of the updated DRX settings and the communication system may be able to work synchronously.

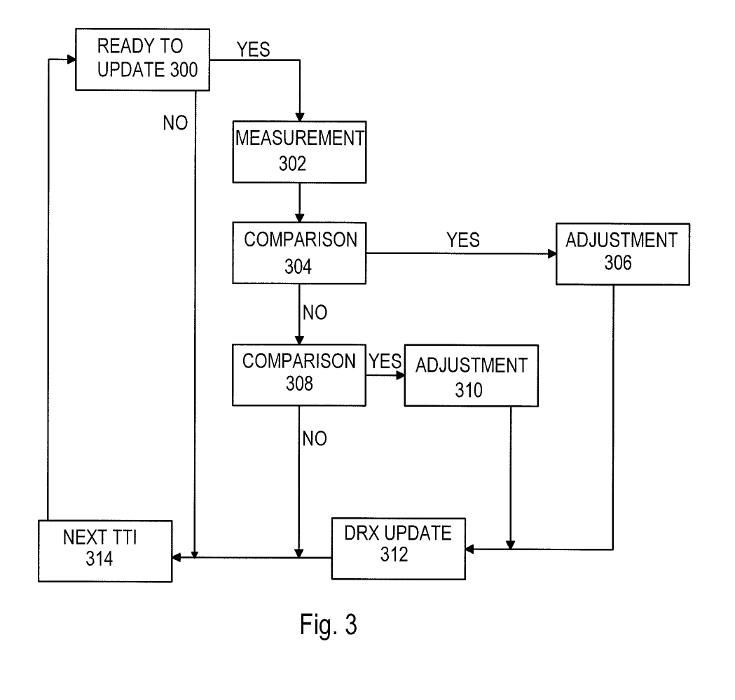

With reference to FIG. 3, let us examine an example of a DRX concept with a DRX controlling ability during a DRX on-period. Clearly the presented example is not the only possible way to implement the control procedure, but several variants for implementing the control procedure exist. FIG. 3 illustrates the control of the DRX settings by means of a flow diagram.

In an embodiment, at least part of the steps at the given exemplary control procedure in FIG. 3 may be performed in the DRX/DTX controller 210 at the RRC layer 206 (referring to FIG. 2). The following parameters may be applied in the adjustment of the DRX settings:

minimum time between DRX updates via RRC;

minimum time between the transmission of a DRX update message and the implementation of the new settings transmitted in said message in the communication between the base station and the terminal device;

on-period duration up-step size (DeltaUp);

on-period duration down-step size (DeltaDown); and

adjustment threshold

The adjustment threshold is the ratio between TTIs needed to empty the current pending data and current on-period duration.

The above parameters may be given pre-defined default values to limit the amount of signaling and the need for DRX settings adjustment. Furthermore, the network operator may be responsible for giving pre-defined default values for the parameters. For instance, with a high adjustment threshold default value, the DRX setting adjustment does not take place as frequently as it would with a low adjustment threshold default value. Another aspect in the setting of the default values may be that the stability of the control procedure may be increased. For instance, there might be some large variations in the measurements conducted over time and without such default values (margins for update), there might be frequently occurring changes, even small changes, in the DRX settings. Margins may be given, e.g., as absolute changes and/or as update rates.

In step 300, the base station may determine during the current TTI, if the terminal device is ready for the DRX setting change, i.e., if the terminal device is awake and if there is a signaling mechanism available between the terminal device and the base station. Furthermore, the base station may determine if the minimum time between the DRX update via RRC has elapsed or not. If the time has elapsed, the terminal device may be acknowledged as ready for the DRX setting change. Moreover, the base station may determine if the minimum time between the transmission of a DRX update message and the implementation of the new settings transmitted in said message in the communication between the base station and the terminal device has elapsed. If the time has elapsed, the terminal device may be understood as ready for the change in the DRX settings.

However, if the terminal device is in a sleep mode or there are no signaling mechanisms available between the terminal device and the base station, the base station may determine that the terminal device is not available for the DRX settings change. Furthermore, if the minimum time between the DRX update via RRC or the minimum time between the transmission of a DRX update message and the implementation of the new settings transmitted in said message in the communication between the base station and the terminal device has not elapsed, the base station may acknowledge that the terminal device is not ready for the DRX update. This is because the effect of the previous setting change may not yet have been utilized. In the case when the terminal device is not available for the DRX settings change, the next TTI may be allowed at step 314 and the same procedure may be repeated starting from step 300. Thus, in this case steps 302-312 may be skipped during the current TTI.

Hence, the minimum time between DRX updates via RRC and the minimum time between the transmission of a DRX update message and the implementation of the new settings transmitted in said message in the communication between the base station and the terminal device can be exploited in the base station to jointly understand when the new DRX settings are expected to be applied so that the terminal device and the base station are synchronized as to the use of the new on- and off-periods 104 and 106, respectively.

In step 302, assuming that the terminal device is available at the current TTI, the base station may perform measurements to obtain knowledge about the current and average traffic situation in the network. The measurements may be performed at the measurement unit 208 and the information regarding the measurements results may be transmitted to the DRX/DTX controller 210. These measurements may include the answers to, but are not limited to, the following questions:

how many bits are currently buffered at the transmitter;

what is the currently supported TBS for the receiver; and

what was the average supported TBS for the receiver in the past.

Furthermore, in step 302, the base station may determine the number of TTIs (NTTI) needed for emptying the current base station buffer given, e.g., the currently reported TBS by the terminal device and a channel quality indicator (CQI).

In step 304, a comparison of whether the NTTI is higher than the multiplication of the on-period duration in TTIs (OnDur) and the adjustment threshold, may be made. In an embodiment, the adjustment threshold is the ratio between the TTIs needed to empty the current pending data and the current on-period duration.

In step 306, assuming that the NTTI is higher than the multiplication of the OnDur and the adjustment threshold, the adjustment to DRX setting may be made in such a way that the OnDur is increased by a minimum of DeltaUp and NTTI, from which the current OnDur is subtracted. DeltaUp denotes the on-period duration up-step size. If step 306 is entered, steps 308 and 310 may be skipped and the control procedure can be continued at step 312.

If, however, the NTTI is not higher than the multiplication of the OnDur and the adjustment threshold, step 306 may be skipped and step 308 can be entered.

In step 308, a comparison of whether the NTTI is lower than the multiplication of the OnDur and the adjustment threshold, may be made.

In step 310, assuming that the NTTI is lower than the multiplication of the OnDur and the adjustment threshold, the adjustment to DRX setting may be made in such a way that the OnDur is decreased by a minimum of DeltaDown and OnDur, from which the current NTTI is subtracted. DeltaDown denotes the on-period duration down-step size.

If, however, the NTTI is not lower than the multiplication of the on-period duration in TTIs (OnDur) and the adjustment threshold, steps 310 and 312 may be skipped and the control procedure may be continued at step 314.

Thus, if the NTTI is neither higher nor lower than the multiplication of the OnDur and the adjustment threshold, the DRX settings may be left unchanged for the current TTI, and the next TTI may be considered after step 314.

In step 312, assuming that the NTTI is either higher or lower than the multiplication of the OnDur and the adjustment threshold, a corresponding update to DRX settings during the current TTI can be performed and at the next TTI, the updated DRX settings may be valid.

In step 314, a period of time may be allowed to pass until the next TTI begins. After this, a restart from the beginning at step 300, with updated DRX parameters (at step 306 or 310) assuming that a need for an update of the DRX settings was observed during the previous TTI, may be performed.

In the case of DTX, the measurements may take place in the terminal device and information regarding the measurement results may be transmitted to the base station. In the base station, the adjustment of the DTX settings may be performed in a manner similar to that in the DRX case explained above.

Embodiments of the invention may be implemented as computer programs in the base station and the terminal device according to an embodiment of the invention. The computer programs comprise instructions for executing a computer process for adaptation of discontinuous reception in a mobile communication system. The computer program implemented in the base station may carry out the required measurements, the DRX control procedure and the logical connections between functional entities as well as the reception and transmission of data. The computer program implemented in the terminal device may carry out the reception and transmission of data and the adjustment of the DRX settings at the terminal device.

The computer program may be stored in a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention was described above with reference to an example according to the accompanying drawings, it is clear that the invention is not restricted thereto but it can be modified in several ways within the scope of the appended claims.

What is claimed is:

1. A method, comprising:
utilizing discontinuous reception/transmission in communication between a transmitter and a receiver;
determining at least one of the following at the transmitter within each predefined time interval: the number of bits that are currently in the buffer of the transmitter, the currently supported transport block set for the receiver and the average supported transport block set for the receiver; and
controlling discontinuous reception/transmission during a discontinuous reception/transmission on-period on the basis of the information regarding the determination.

2. The method of claim 1, further comprising: utilizing at least one of the following parameters:
minimum time between a discontinuous reception/transmission settings updates;
minimum time between the transmission of a discontinuous reception/transmission settings update message and the implementation of the new settings transmitted in said message in the communication between the transmitter and the receiver;
on-period duration up-step size of a discontinuous reception/transmission concept;
on-period duration down-step size of a discontinuous reception/transmission concept; and
adjustment threshold, wherein the adjustment threshold is the ratio between predefined time intervals needed to empty the current pending data at the transmitter and current on-period duration of a discontinuous reception/transmission concept

3. The method of claim 1, wherein the determination result is applied to determine the number of predefined time intervals needed to empty the buffer of the transmitter.

4. The method of claim 3, wherein the number of predefined time intervals needed to empty the buffer of the transmitter is compared against the multiplication of the current discontinuous reception/transmission on-period duration of a discontinuous reception/transmission concept and the adjustment threshold.

5. The method of claim 4, wherein the discontinuous reception/transmission on-period duration is increased by a minimum of the on-period duration up-step size and the number of predefined time intervals needed to empty the buffer of the transmitter, from which the current discontinuous reception/transmission on-period duration is subtracted if the number of predefined time intervals needed to empty the buffer of the transmitter is found to be higher than the multiplication of the current discontinuous reception/transmission on-period duration and the adjustment threshold.

6. The method of claim 4, wherein the discontinuous reception/transmission on-period duration is decreased by a minimum of the on-period duration down-step size and the current discontinuous reception/transmission on-period duration, from which the number of predefined time intervals needed to empty the buffer of the transmitter is subtracted if the number of predefined time intervals needed to empty the buffer of the transmitter is found to be lower than the multiplication of the current discontinuous reception/transmission on-period duration and the adjustment threshold.

7. The method of claim 4, wherein the discontinuous reception/transmission on-period duration is left unchanged if the number of predefined time intervals needed to empty the buffer of the transmitter is found to be neither higher nor lower than the multiplication of the current discontinuous reception/transmission on-period duration and the adjustment threshold.

8. The method of claim 1, further comprising: adjusting at least one of the following discontinuous reception/transmission settings:
discontinuous reception/transmission on-period duration;
discontinuous reception/transmission period duration; and
timing/phase of the starting of the discontinuous reception/transmission periods.

9. The method of claims 2, wherein the discontinuous reception/transmission settings are left unchanged if at least one of the following has not elapsed: the minimum time between discontinuous reception/transmission settings updates and the minimum time between the transmission of a discontinuous reception/transmission settings update message and the implementation of the new settings transmitted in said message in the communication between the transmitter and the receiver.

10. An apparatus, comprising:
a controller configured to receive information about at least one of the following within each predefined time interval: the number of bits that are currently in the buffer of a transmitter, the currently supported transfer block set for a receiver and the average supported transfer block set for the receiver, wherein the controller is further configured to control discontinuous reception/transmission during a discontinuous reception/transmission on-period on the basis of the received information.

11. The apparatus of claim 10, further comprising, when discontinuous reception concept is applied:
a measurement unit configured to determine at least one of the following within each predefined time interval: the number of bits that are currently in the buffer of the network element, the currently supported transfer block set for the terminal device and the average supported transfer block set for the terminal device, wherein the measurement unit is further configured to transmit information regarding the determination to the controller.

12. The apparatus of claim 10, wherein the controller is further configured to apply the determination result to determine the number of predefined time intervals needed to empty the buffer of the transmitter.

13. The apparatus of claim 12, wherein the controller is further configured to compare the number of predefined time intervals needed to empty the buffer of the transmitter against the multiplication of the current discontinuous reception/transmission on-period duration of a discontinuous reception/transmission concept and the adjustment threshold.

14. The apparatus of claim 13, wherein the controller is further configured to increase the discontinuous reception/transmission on-period duration by a minimum of the on-period duration up-step size and the number of predefined time intervals needed to empty the buffer of the transmitter, from which the current discontinuous reception/transmission on-period duration is subtracted if the number of predefined time intervals needed to empty the buffer of the transmitter is found to be higher than the multiplication of the current discontinuous reception/transmission on-period duration and the adjustment threshold.

15. The apparatus of claim 13, wherein the controller is further configured to decrease the discontinuous reception/transmission on-period duration by a minimum of the on-period duration down-step size and the current discontinuous reception/transmission on-period duration from which the number of predefined time intervals needed to empty the buffer of the transmitter is subtracted, if the number of predefined time intervals needed to empty the buffer of the transmitter is found to be lower than the multiplication of the current discontinuous reception/transmission on-period duration and the adjustment threshold.

16. The apparatus of claim 13, wherein the controller is further configured to leave the discontinuous reception/transmission on-period duration unchanged if the number of predefined time intervals needed to empty the buffer of the transmitter is found to be neither higher nor lower than the multiplication of the current discontinuous reception/transmission on-period duration and the adjustment threshold.

17. The apparatus of claim 10, wherein the controller is further configured to adjust at least one of the following of the discontinuous reception/transmission settings:
discontinuous reception/transmission on-period duration;
discontinuous reception/transmission period duration; and
timing/phase of the starting of the discontinuous reception/transmission periods.

18. The apparatus of claim 17, wherein the controller is further configured to leave the discontinuous reception/transmission settings unchanged if at least one of the following has not elapsed: a minimum time between discontinuous reception/transmission settings updates and a minimum time between the transmission of a discontinuous reception/transmission settings update message and the implementation of the new settings transmitted in said message in the communication between the transmitter and the receiver.

19. A computer program product embodied in a distribution medium and comprising program instructions for:
utilizing discontinuous reception/transmission in communication between a transmitter and a receiver;
determining at least one of the following at the transmitter within each predefined time interval: the number of bits that are currently in the buffer of the transmitter, the currently supported transport block set for the receiver and the average supported transport block set for the receiver; and
controlling discontinuous reception/transmission during a discontinuous reception/transmission on-period on the basis of the information regarding the determination.

20. The computer program product of claim 19, wherein the distribution medium includes at least one of the following media: a computer readable medium, a program storage medium, a record medium, a computer readable memory, a computer readable software distribution package, a computer readable signal, a computer readable telecommunications signal, and a computer readable compressed software package.
